(19) United States
(12) Patent Application Publication
(10) Pub. No.: US 2008/0182625 A1
(43) Pub. Date: Jul. 31, 2008

(54) RF transeiver system with antenna configuration control and methods for use therewith

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/700,581

(22) Filed: Jan. 30, 2007

(51) Int. Cl. H04M 1/00

(52) U.S. Cl. 455/562.1

(57) ABSTRACT

An RF transceiver system includes a configurable antenna system that includes an antenna control module that is capable of controlling the configurable antenna system, in response to a control signal, to each of a plurality of antenna configurations. An RF receiver receives a received signal from the configurable antenna system in a receive mode and generates inbound data from the received signal, the inbound data including received antenna control data received from a first remote station. A processing module generates the control signal in response to the received antenna control data to command the antenna control module to control the configurable antenna system to a selected one of the plurality of antenna configurations.

### CROSS-REFERENCE TO RELATED APPLICATIONS

None

### BACKGROUND OF THE INVENTION

1. Technical Field of the Invention

This invention relates generally to wireless communications systems and more particularly to radio transceivers used within such wireless communication systems.

2. Description of Related Art

Communication systems are known to support wireless and wire line communications between wireless and/or wire line communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna through an antenna interface and includes a low noise amplifier, one or more intermediate frequency stages, a filtering stage, and a data recovery stage. The low noise amplifier (LNA) receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

Many wireless communication systems include receivers and transmitters that can operate over a range of possible conditions corresponding to the position of the remote transceivers they are communication with, the prevailing noise and interference conditions. Many such receivers and transmitters cannot adapt to many such changes in a manner that is efficient. Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a wireless communication system in accordance with the present invention.

FIG. 2 is a schematic block diagram of a wireless communication system in accordance with the present invention.

FIG. 3 is a schematic block diagram of a wireless communication device 10 in accordance with the present invention.

FIG. 4 is a schematic block diagram of a wireless communication device 30 in accordance with the present invention.

FIG. 5 is a schematic block diagram of an RF transceiver 125 in accordance with the present invention.

FIG. 6 is a schematic block diagram of an antenna control module 225 in accordance with an embodiment of the present invention.

FIG. 7 is a schematic block diagram of an antenna control module 225 in accordance with a further embodiment of the present invention.

FIG. 8 is a graphical representation of several antenna beam patterns in accordance with the present invention.

FIG. 9 is a flowchart representation of a method in accordance with an embodiment of the present invention.

FIG. 10 is a flowchart representation of a method in accordance with an embodiment of the present invention.

FIG. 11 is a flowchart representation of a method in accordance with an embodiment of the present invention.

FIG. 12 is a flowchart representation of a method in accordance with an embodiment of the present invention.

### DETAILED DESCRIPTION OF THE INVENTION

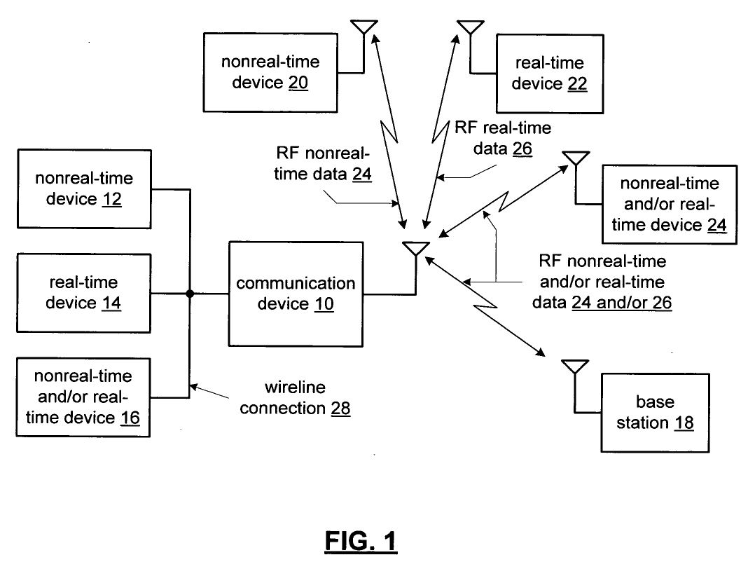

FIG. 1 is a schematic block diagram of an embodiment of a communication system in accordance with the present invention. In particular a communication system is shown that includes a communication device 10 that communicates real-time data 24 and/or non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

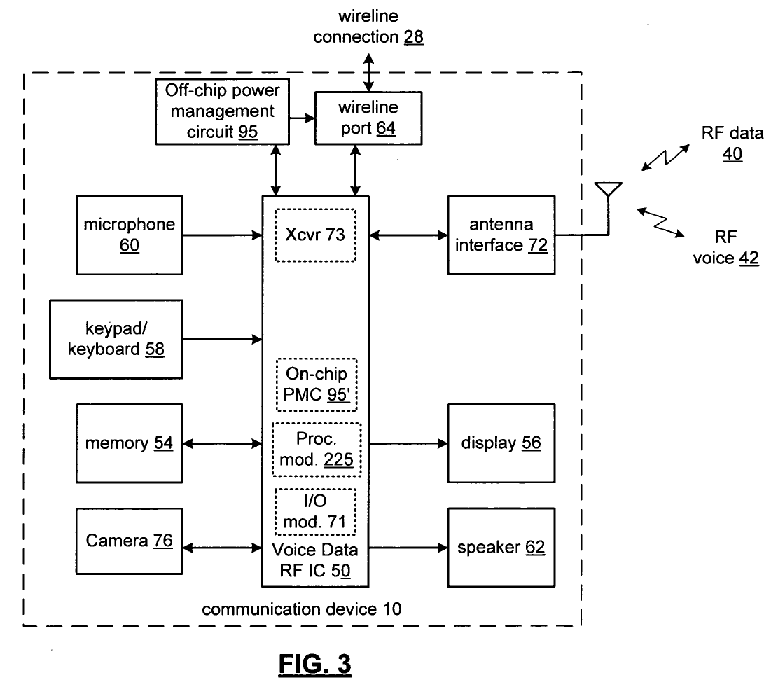

In an embodiment of the present invention, the communication device 10 includes an integrated circuit, such as a combined voice, data and RF integrated circuit that includes one or more features or functions of the present invention. Such integrated circuits shall be described in greater detail in association with FIGS. 3-12 that follow.

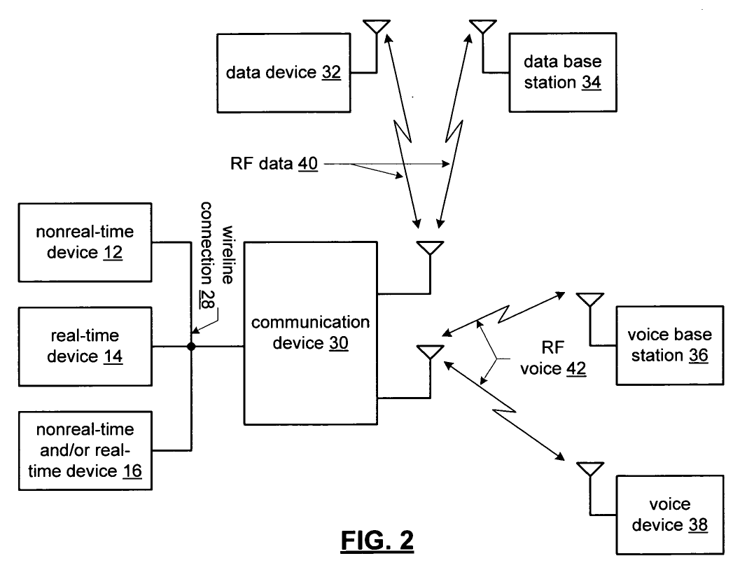

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes two separate wireless transceivers for communicating, contemporaneously, via two or more wireless communication protocols with data device 32 and/or data base station 34 via RF data 40 and voice base station 36 and/or voice device 38 via RF voice signals 42.

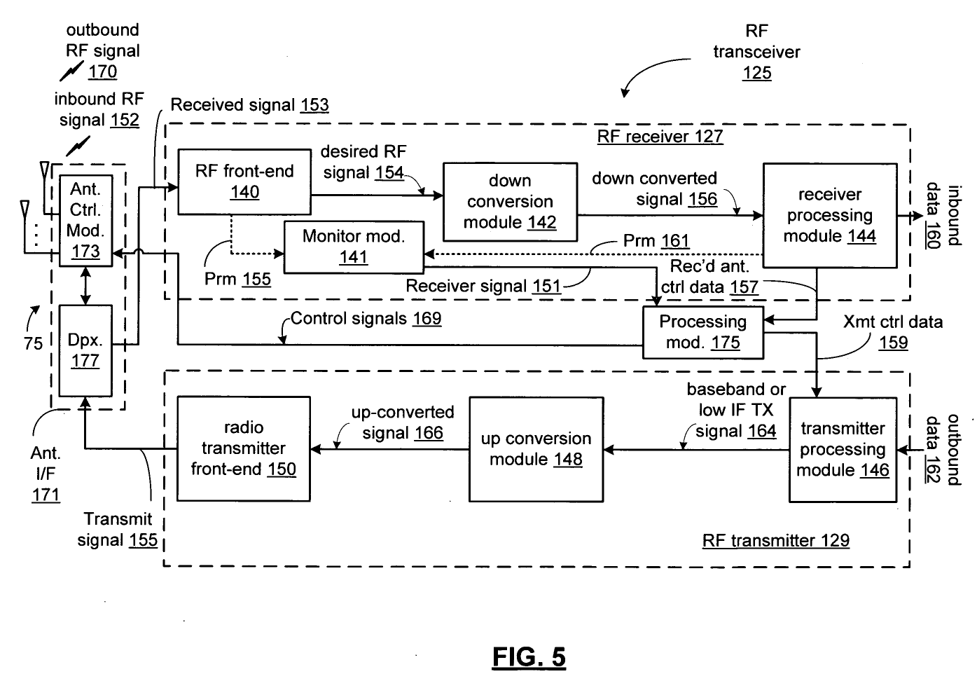

FIG. 3 is a schematic block diagram of an embodiment of an integrated circuit in accordance with the present invention. In particular, a voice data RF integrated circuit (IC) 50 is shown that implements communication device 10 in conjunction with microphone 60, keypad/keyboard 58, memory 54, speaker 62, display 56, camera 76, antenna interface 52 and wireline port 64. In addition, voice data RF IC 50 includes a transceiver 73 with RF and baseband modules for formatting and modulating data into RF real-time data 26 and non-real-time data 24 and transmitting this data via an antenna interface 72 and antenna 73, such as an configurable antenna system that will be described in greater detail in conjunction with FIGS. 5-12. Further, voice data RF IC 50 includes an input/output module 71 with appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Off-chip power management circuit 95 includes one or more DC-DC converters, voltage regulators, current regulators or other power supplies for supplying the voice data RF IC 50 and optionally the other components of communication device 10 and/or its peripheral devices with supply voltages and or currents (collectively power supply signals) that may be required to power these devices. Off-chip power management circuit 95 can operate from one or more batteries, line power and/or from other power sources, not shown. In particular, off-chip power management module can selectively supply power supply signals of different voltages, currents or current limits or with adjustable voltages, currents or current limits in response to power mode signals received from the voice data RF IC 50. Voice Data RF IC 50 optionally includes an on-chip power management circuit 95′ for replacing the off-chip power management circuit 95.

In an embodiment of the present invention, the voice data RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the Voice Data RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

In operation, the voice data RF IC 50 executes operational instructions that implement one or more of the applications (real-time or non-real-time) attributed to communication devices 10 and 30 as discussed in conjunction with FIGS. 1 and 2. Further, RF IC 50 operates to control the configuration of the configurable antenna system 73, as will be discussed in greater detail in association with the description that follows, and particularly in conjunction with FIGS. 5-12.

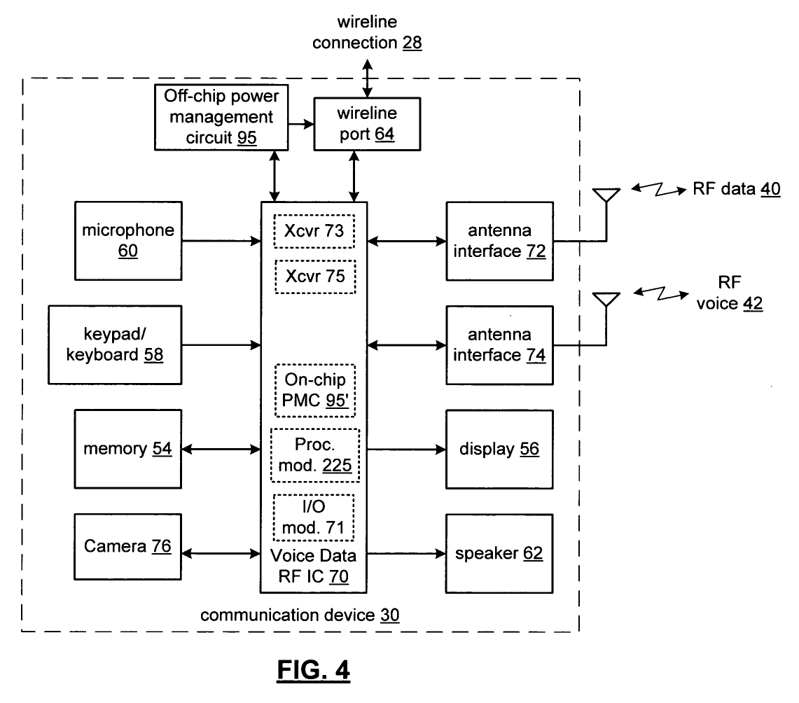

FIG. 4 is a schematic block diagram of another embodiment of an integrated circuit in accordance with the present invention. In particular, FIG. 4 presents a communication device 30 that includes many common elements of FIG. 3 that are referred to by common reference numerals. Voice data RF IC 70 is similar to voice data RF IC 50 and is capable of any of the applications, functions and features attributed to voice data RF IC 50 as discussed in conjunction with FIG. 3. However, voice data RF IC 70 includes two separate wireless 73 and 75 for communicating, contemporaneously, via two or more wireless communication protocols via RF data 40 and RF voice signals 42.

In operation, the voice data RF IC 70 executes operational instructions that implement one or more of the applications (real-time or non-real-time) attributed to communication device 10 as discussed in conjunction with FIG. 1. Further, RF IC 70 operates to control the configuration of the configurable antenna systems 73, as will be discussed in greater detail in association with the description that follows, and particularly in conjunction with FIGS. 5-12.

FIG. 5 is a schematic block diagram of an RF transceiver 125, such as transceiver 73 or 75, which may be incorporated in communication devices 10 and/or 30. The RF transceiver 125 includes an RF transmitter 129, an RF receiver 127 and a processing module 175. The RF receiver 127 includes a RF front end 140, a down conversion module 142, monitor module 141 and a receiver processing module 144. The RF transmitter 129 includes a transmitter processing module 146, an up conversion module 148, and a radio transmitter front-end 150.

As shown, the receiver and transmitter are each coupled to configurable antenna system 175 through an off-chip antenna interface 171 that includes a diplexer (duplexer) 177, that couples the transmit signal 155 to the antenna to produce outbound RF signal 170 and couples inbound signal 152 to produce received signal 153. While a single antenna is represented, the receiver and transmitter may each use separate configurable antenna systems that each include two or more antennas Each of the antenna elements of these configurable antenna systems may be fixed, programmable, and antenna array or other antenna configuration. Further, the antenna structure of the wireless transceiver may depend on the particular standard(s) to which the wireless transceiver is compliant and the applications thereof.

In operation, the transmitter receives outbound data 162 from a host device or other source via the transmitter processing module 146. The transmitter processing module 146 processes the outbound data 162 in accordance with a particular wireless communication standard (e.g., IEEE 802.11, Bluetooth, RFID, GSM, CDMA, et cetera) to produce baseband or low intermediate frequency (IF) transmit (TX) signals 164. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further note that the transmitter processing module 146 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 146 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up converted signals 166 based on a transmitter local oscillation 168.

The radio transmitter front end 150 includes a power amplifier and may also include a transmit filter module. The power amplifier amplifies the up converted signals 166 to produce outbound RF signals 170, which may be filtered by the transmitter filter module, if included. The antenna structure transmits the outbound RF signals 170 to a targeted device such as a RF tag, base station, an access point and/or another wireless communication device.

The receiver receives inbound RF signals 152 via the configurable antenna system 75 through off-chip antenna interface 171 that operates to process the inbound RF signal 152 into received signal 153 for the receiver front-end 140. The configurable antenna system 75 includes an antenna control module 173 that is capable of controlling the configurable antenna system, in response to a control signal 169, to each of a plurality of antenna configurations.

The down conversion module 70 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound data 160. The processing performed by the receiver processing module 144 includes, but is not limited to, digital intermediate frequency to baseband conversion, demodulation, demapping, depuncturing, decoding, and/or descrambling. Note that the receiver processing modules 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, RF receiver 127 receives a received signal 153 from the configurable antenna system 75 in a receive mode and generates inbound data 160 from the received signal that includes received antenna control data 157 received from a first remote station. Processing module 175 generates the control signal 169 in response to the received antenna control data 157, commanding the antenna control module 173 to control the configurable antenna system 75 to a selected one of the plurality of antenna configurations. In an embodiment of the present invention, the received antenna control data 157 includes information from the remote station in communication with the RF transceiver that can include a receiver performance parameter of the remote receiver such as a received signal strength indication (RSSI), signal to noise ratio (SNR), signal to interference and noise ration (SINR), and/or an antenna configuration of the remote receiver. This allows the configuration of the configurable antenna system, such as the beam pattern, gain, or other antenna characteristics to be adapted to how well the remote station receives the outbound RF signal 152 signal from the RF transceiver 125. In particular, the gain of the antenna, or the gain of the antenna in the direction of the remote station can be boosted if required, such as by boosting the gain in the direction of the remote station, based on the performance of the received signal.

It should be noted that RF transceiver 125 can further operate as the remote station to other RF transceivers by generating a receiver signal 151 that includes a receiver performance parameter generated by monitor module 141 in response to parameter 155, such as RSSI, SNR and/or SINR and parameter 161, such as BER and/or other performance parameters and/or in response to the antenna configuration selected by processing module 175. Processing module 175 generates transmit data 159 that is transmitted by RF transmitter 129 to the other RF transceivers. In particular, RF transmitter 129 generates transmit signal 155 from outbound data 162, the outbound data including transmit antenna data 159.

Processing module 175 generates control signals 169 to control the configuration of the configurable antenna system 75 in response to the receiver signal 151 and/or the received antenna control data 157 that may include receiver performance parameters, the remote stations antenna characteristics and optionally other data. In one mode of operation, the processing module 175 is preprogrammed with the particular control signals 169 that correspond to receiver signals 151 and received control data 157, so that logic or other circuitry or programming, such as via a look-up table, can be used to retrieve the particular control signals required for the particular values of the receiver signal 151 and/or received antenna data 157. In a further mode of operation, the processing module 175 iteratively tunes or utilizes feedback control techniques such as optimal control, linear quadratic regulator, proportional integral derivative (PID) control or other control techniques to control the configuration of the configurable antenna system 75 to obtain desired values of the receiver performance parameters.

In an embodiment of the present invention, processing module 175 performs various processing steps to implement the functions and features described herein. Such a processing module can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 175 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In an embodiment of the present invention, the particular configuration of the configurable antenna system 75 can be selected dynamically based on other conditions, such as whether the RF transceiver 125 is transmitting in a transmit mode or receiving in a receive mode. For instance, the processing module 175 can generate a first value of the control signal 169 corresponding to a first of the plurality of antenna configurations in the transmit mode, and a second value of the control signal 169 corresponding to a second of the plurality of antenna configurations in the receive mode.

Further, the antenna configuration can be selected based on the particular station or stations that the RF transceiver is transmitting to or the particular station or stations that the RF transceiver is expecting to be receiving from. For instance, the processing module 175 can generate a first value of the control signal 169 corresponding to a first of the plurality of antenna configurations when transmitting to a first remote station, and a second value of the control signal corresponding to a second of the plurality of antenna configurations when transmitting to a second remote station. These are merely examples of the broad range of applications enabled with the RF transceiver 125 as described herein.

FIG. 6 is a schematic block diagram of an antenna control module 225 in accordance with an embodiment of the present invention. In particular, this antenna control module 225 is used in a configurable antenna system 75 that includes a plurality of individual antennas 206, 208, and 210, with corresponding beam patterns 200, 202, and 204 that are shown as examples in two dimensions, but are represented merely as examples of the range of possible beam patterns that are possible within the broad scope of the present invention. In operation, a particular antenna configuration, corresponding to a particular antenna pattern (206, 208 or 210) is implemented in response to the control signals 169 by coupling the individual antenna, 202, 202 or 204 having that particular beam pattern, via coupling network 220 to impedance matching network 226 and to diplexer (duplexer) 177. Impedance matching network 226 includes one or more inductors, capacitors, transformers and/or other circuit elements to match the impedance of the selected antenna to the diplexer and or the RF transmitter or RF receiver coupled thereto. Impedance matching network 226 optionally is responsive to the control signal 169, having multiple impedance matching configurations to impedance match the particular antenna (200, 202 or 204) that is selected. Further impedance matching network 226 optionally includes bandpass filtration for passing only RF signals within a desired range of frequencies.

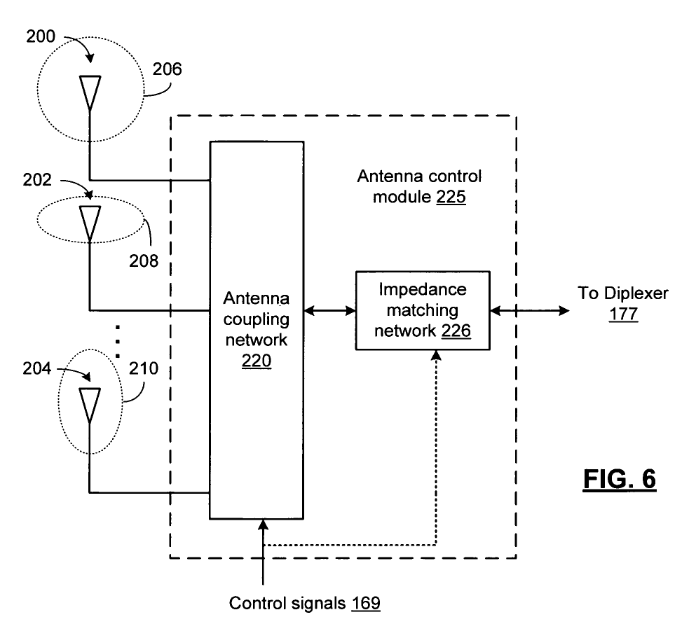

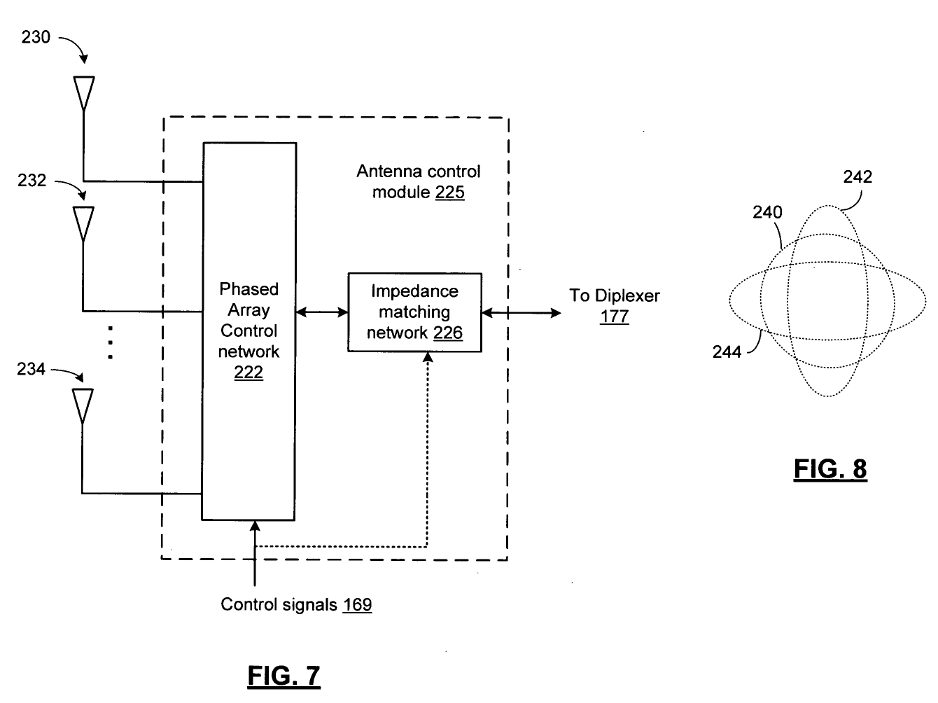

FIG. 7 is a schematic block diagram of an antenna control module 225 in accordance with a further embodiment of the present invention. In particular, this configuration operates with a phased array of antennas 230, 232 and 234. Phased array control network 222 responds to control signals 169 to produce a desired antenna configuration, such as a desired beam pattern or other antenna configuration by controlling the phase and/or magnitude of the antenna current produced by the antenna 230, 232 and 234 in the receive mode or the drive currents of antennas 230, 232 and 234 in the transmit mode. As before, impedance matching network 226 can optionally adapt to the particular antenna configuration that is selected by control signals 169.

FIG. 8 is a graphical representation of several antenna beam patterns in accordance with the present invention. In particular, beam patterns 240, 244 and 242 merely represent two dimensional examples of the many possible beam patterns that could be produced within the broad scope of the present invention.

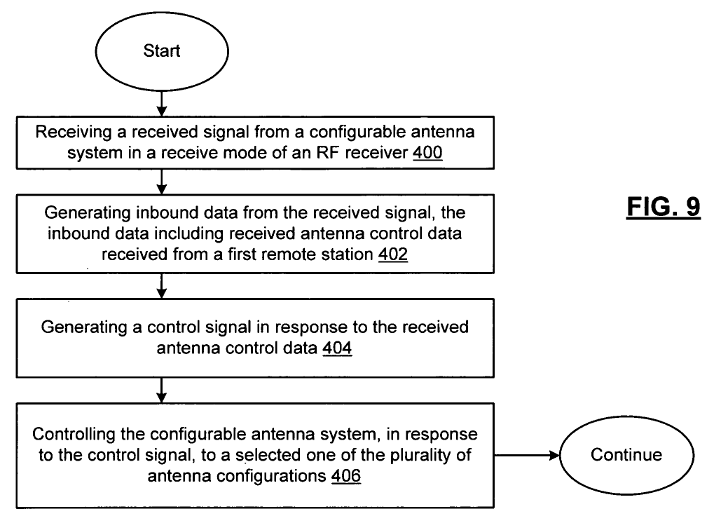

FIG. 9 is a flowchart representation of a method in accordance with an embodiment of the present invention. In particular a method is presented for use with one or more features or functions presented in conjunction with FIGS. 1-8. In step 400, a received signal is received from a configurable antenna system in a receive mode of an RF receiver. In step 402, inbound data is generated from the received signal, the inbound data including received antenna control data received from a first remote station. In step 404, a control signal is generated in response to the received antenna control data. In step 406, the configurable antenna system is controlled in response to a control signal to a selected one of a plurality of antenna configurations.

In an embodiment of the present invention, the plurality of antenna configurations include a first antenna configuration that produces a first beam pattern and a second antenna configuration that produces a second beam pattern. In addition, step 406 can include controlling a beam pattern of a phased array antenna system, based on the control signal. Also, step 406 can include selecting one of a plurality of individual antenna elements, based on the control signal. The received antenna data can represents at least one receiver performance parameter of the first remote station and/or a remote station antenna configuration from the first remote station.

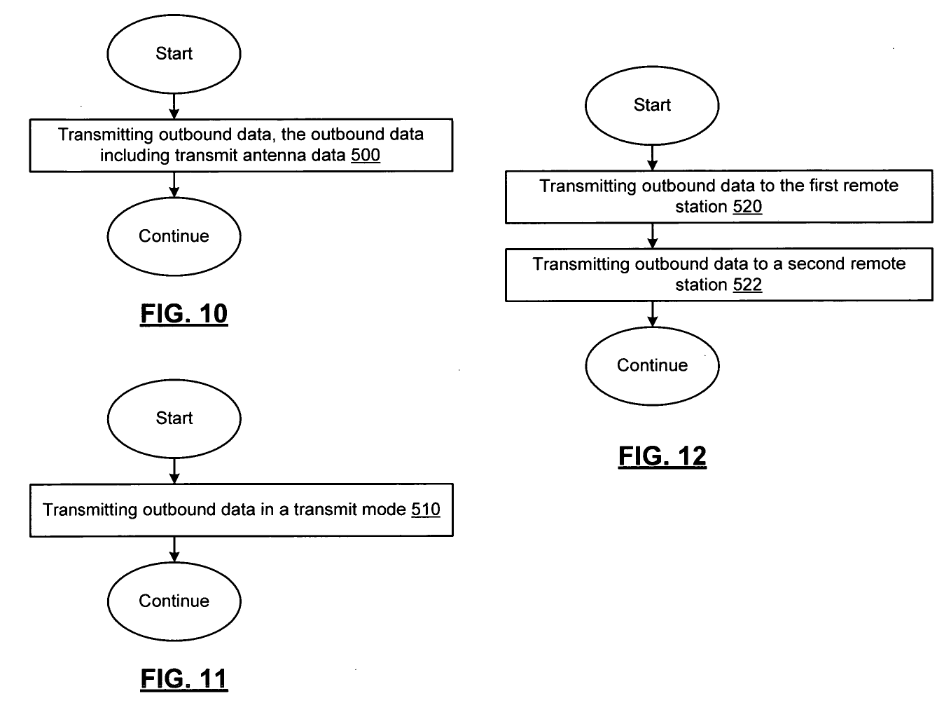

FIG. 10 is a flowchart representation of a method in accordance with an embodiment of the present invention. In particular a method is presented for use with one or more features or functions presented in conjunction with FIGS. 9. Step 500 includes transmitting outbound data, the outbound data including transmit antenna data. In an embodiment of the present invention, the transmit antenna data represents at least one receiver performance parameter of the RF receiver and/or the selected one of the plurality of antenna configurations.

FIG. 11 is a flowchart representation of a method in accordance with an embodiment of the present invention. In particular a method is presented for use with one or more features or functions presented in conjunction with FIGS. 9. Step 510 includes transmitting outbound data in a transmit mode. In this embodiment, step 406 can include generating a first value of the control signal corresponding to a first of the plurality of antenna configurations in a transmit mode, and generating a second value of the control signal corresponding to a second of the plurality of antenna configurations in a receive mode.

FIG. 12 is a flowchart representation of a method in accordance with an embodiment of the present invention. In particular a method is presented for use with one or more features or functions presented in conjunction with FIGS. 9. Step 520 includes transmitting outbound data to the first remote station. Step 522 includes transmitting outbound data to a second remote station. In this embodiment, step 406 can include generating a first value of the control signal corresponding to a first of the plurality of antenna configurations when transmitting to the first remote station, and generating a second value of the control signal corresponding to a second of the plurality of antenna configurations when transmitting to the second remote station.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors discussed above may be field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A (radio frequency) RF transceiver system comprising:
a configurable antenna system that includes an antenna control module that is capable of controlling the configurable antenna system, in response to a control signal, to each of a plurality of antenna configurations;
an RF receiver, coupled to the configurable antenna system, that receives a received signal from the configurable antenna system in a receive mode and that generates inbound data from the received signal, the inbound data including received antenna control data received from a first remote station; and
a processing module, coupled to the RF receiver, that generates the control signal in response to the received antenna control data and that commands the antenna control module to control the configurable antenna system to a selected one of the plurality of antenna configurations.

2. The RF transceiver system of claim 1 wherein the plurality of antenna configurations include a first antenna configuration that produces a first beam pattern and a second antenna configuration that produces a second beam pattern.

3. The RF transceiver system of claim 1 wherein the configurable antenna system includes a phased array antenna system controllable to each of a plurality of beam patterns, based on the control signal.

4. The RF transceiver system of claim 1 wherein the configurable antenna system selects one of a plurality of individual antenna elements, based on the control signal.

5. The RF transceiver system of claim 1 wherein the received antenna data represents at least one receiver performance parameter of the first remote station.

6. The RF transceiver system of claim 1 wherein the received antenna data represents a remote station antenna configuration from the first remote station.

7. The RF transceiver system of claim 1 further comprising an RF transmitter, coupled to the configurable antenna system, that generates a transmit signal from outbound data, the outbound data including transmit antenna data.

8. The RF transceiver system of claim 7 wherein the transmit antenna data represents at least one receiver performance parameter of the RF receiver.

9. The RF transceiver system of claim 7 wherein the transmit antenna data represents the selected one of the plurality of antenna configurations.

10. The RF transceiver of claim 1 further comprising:
an RF transmitter, coupled to the configurable antenna system, for transmitting outbound data in a transmit mode;
wherein the processing module generates a first value of the control signal corresponding to a first of the plurality of antenna configurations in a transmit mode, and wherein the processing module generates a second value of the control signal corresponding to a second of the plurality of antenna configurations in a receive mode.

11. The RF transceiver of claim 1 further comprising:
an RF transmitter, coupled to the configurable antenna system, for transmitting outbound data in a transmit mode;
wherein the processing module generates a first value of the control signal corresponding to a first of the plurality of antenna configurations when transmitting to the first remote station, and wherein the processing module generates a second value of the control signal corresponding to a second of the plurality of antenna configurations when transmitting to a second remote station.

12. The RF transceiver of claim 1 wherein the RF receiver and the processing module are implemented on a voice, data and RF integrated circuit.

13. A method comprising:
receiving a received signal from a configurable antenna system in a receive mode of an RF receiver;
generating inbound data from the received signal, the inbound data including received antenna control data received from a first remote station;
generating a control signal in response to the received antenna control data; and
controlling the configurable antenna system, in response to a control signal, to a selected one of a plurality of antenna configurations.

14. The method of claim 13 wherein the plurality of antenna configurations include a first antenna configuration that produces a first beam pattern and a second antenna configuration that produces a second beam pattern.

15. The method of claim 13 wherein step of controlling the configurable antenna system includes controlling a beam pattern of a phased array antenna system, based on the control signal.

16. The method of claim 13 wherein step of controlling the configurable antenna system includes selecting one of a plurality of individual antenna elements, based on the control signal.

17. The method of claim 13 wherein the received antenna data represents at least one receiver performance parameter of the first remote station.

18. The method of claim 13 wherein the received antenna data represents a remote station antenna configuration from the first remote station.

19. The method of claim 13 further comprising:
transmitting outbound data, the outbound data including transmit antenna data.

20. The method of claim 19 wherein the transmit antenna data represents at least one receiver performance parameter of the RF receiver.

21. The method of claim 19 wherein the transmit antenna data represents the selected one of the plurality of antenna configurations.

22. The method claim 13 further comprising:
transmitting outbound data in a transmit mode;
wherein the step of controlling the configurable antenna system includes generating a first value of the control signal corresponding to a first of the plurality of antenna configurations in a transmit mode, and generating a second value of the control signal corresponding to a second of the plurality of antenna configurations in a receive mode.

23. The method of claim 13 further comprising:
transmitting outbound data to the first remote station;
transmitting outbound data to a second remote station;
wherein the step of controlling the configurable antenna system includes generating a first value of the control signal corresponding to a first of the plurality of antenna configurations when transmitting to the first remote station, and generating a second value of the control signal corresponding to a second of the plurality of antenna configurations when transmitting to the second remote station.
